(19) United States
(12) Patent Application Publication
(10) Pub. No.: US 2007/0145759 A1
(43) Pub. Date: Jun. 28, 2007

(54) MOBILE DEVICE FOR HANDLING MATERIAL

(75) Inventors: Patrick Lee Crawford, Shawano, WI (US); Patrick James Crawford, Shawano, WI (US); John H. Lambert, Shawano, WI (US)

Correspondence Address: NIKOLAI & MERSEREAU, P.A., 900 SECOND AVENUE SOUTH, SUITE 820, MINNEAPOLIS, MN, 55402, US

(73) Assignee: TIMBERPRO INC., Shawano, WI (US)

(21) Appl. No.: 11/306,434

(22) Filed: Dec. 28, 2005

(51) Int. Cl. B60J 9/00

(52) U.S. Cl. 296/1.01

(57) ABSTRACT

A boom member (96) is pivotable relative to a platform (58) in a boom plane located intermediate the block ends of an engine (E) also mounted on the platform (58). The platform (58) with a cab (C) is rotatable by a turntable (46) 360° within the extent of a frame (12) moveable between adjacent rows of trees. The cab (C) includes corner partitions (23) extending between the front partition (228) and side partitions (226) at acute angles. A gullwing cover (200) is pivotably mounted to the platform (58) and has a ladder (208) extending over a cutout (204b) which extends over the engine (E) in an operating position and generally vertically in a service position. The air cleaner (71) is held in a spaced, parallel relation to the radiator (R) by its purge tank (65). The radiator (R) and a hydraulic heat exchanger (77) are in a spaced, parallel arrangement on opposite sides of the turntable axis.

### BACKGROUND

The present invention generally relates to devices for handling material, particularly to mobile devices for handling material, and specifically in the preferred form to mobile tree handling apparatus.

The introduction of tree handling apparatus represented by U.S. Pat. Nos. 4,326,571; 4,565,486; and 4,583,908 obtained a significant advantage in the marketplace in selectively cutting from a row of trees. This arose due to its ability to rotate its platform throughout 360° within the overall width of the apparatus which is able to pass between adjacent rows of trees. Improvements to the initial machine represented in U.S. Pat. No. 4,326,571 included the ability to maintain the platform level while the apparatus worked on slopes such as mountain sides.

However, even such excellent devices have experienced some limitations for which further improvement was needed. In particular, it was clearly desired to maintain the ability to rotate the platform throughout 360° within the overall width of the apparatus, but it is desired to increase operator visibility from the cab even though a larger engine was mounted to the platform to allow the use of an articulated frame and to increase access to operative components for servicing.

### SUMMARY

The above needs and other problems in the field of material handling devices have been solved by providing, in the preferred form, apparatus and methods for handling material. Such apparatus and methods include several inventive features which are believed to cooperate together to provide synergistic results but which could be utilized singly or in other combinations to overcome deficiencies and shortcomings in previously existing material handling attempts.

In one aspect of the present invention, a platform having a cab is rotatable 360° about a turntable axis relative to a frame movable along a work surface. The turntable axis is located intermediate an engine and a ram axis. The ram axis pivotally connects a hydraulic ram to the platform, with extension and retraction of the hydraulic ram pivoting a main boom member in a boom plane about a boom axis extending parallel to the platform and adjacent to the turntable axis. The boom plane is located intermediate the first and second block ends of the engine.

In another aspect of the present invention, the radiator for an engine and the hydraulic heat exchanger of a material handling device are mounted to a platform tangent to and on opposite sides of a turntable axis of the platform. The engine is positioned intermediate the hydraulic heat exchanger and the radiator, with the crank axis of the engine being offset therefrom in the preferred form. In preferred aspects, the outer side partition of the cab extends parallel to and contiguous with the hydraulic heat exchanger.

In an additional aspect of the present invention, an air cleaner is secured to and held in a spaced relation from a radiator by a purge tank in fluid communication with the radiator. In preferred aspects, the air cleaner has a generally cylindrical shape having a cleaner axis parallel to the radiator.

Further, in another aspect of the present invention, a gullwing cover having generally L-shaped cross sections includes a support panel pivotally mounted on the platform between a horizontal condition contiguous with the platform in a service portion and vertically from the platform in an operating position. The cover panel extends horizontally over the engine in the operating position and extends vertically from the platform in the service position. In the preferred form, a ladder is slideably mounted over a cutout in the cover panel.

In still further aspects of the present invention, a corner partition extends between a front partition and an outer side partition of a cab mounted upon a platform rotatable about a turntable axis. Thus, the corner partition minimizes the radial extent from the turntable axis and increases visibility. In preferred aspects, outer side roof partitions connected to the side partitions and the corner partitions extend at an acute angle to the side partitions. Additionally, a roof window is connected to the front partition, the corner partition, and the side roof partitions and extends at a non-parallel, acute angle relative to the platform. A roof partition extends at an obtuse angle to the roof window and is connected to the outer side roof partitions. Furthermore, windows in the side partitions have bottom linear edges parallel to and spaced from the upper linear edges of support plates to which a boom and a hydraulic ram are pivotally mounted and which extend at an acute angle to the platform.

The present invention will become clearer in light of the following detailed description of an illustrative embodiment of this invention described in connection with the drawings.

### DESCRIPTION OF THE DRAWINGS

The illustrative embodiment may best be described by reference to the accompanying drawings where:

FIG. 1 shows a perspective view of a material handling device according to the preferred teachings of the present invention.

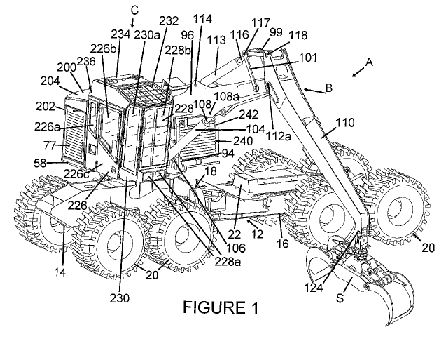

FIG. 2 shows a partial, perspective view of the material handling device of FIG. 1 with portions broken away and with the platform rotated.

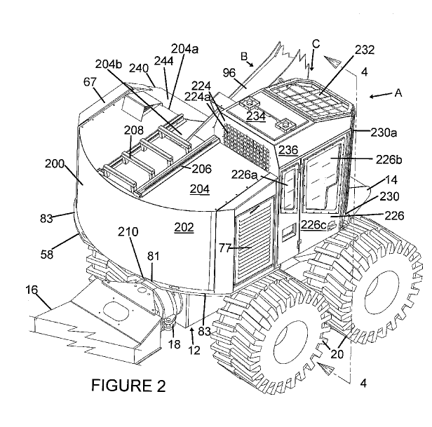

FIG. 3 shows a partial, perspective view of the material handling device of FIG. 1 with portions broken away, with the platform rotated, and with the gullwing cover in its service position.

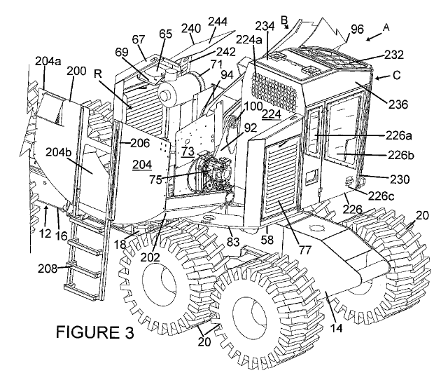

FIG. 4 shows a partial, cross sectional view of the material handling device of FIG. 1 according to section line 4-4 of FIG. 2.

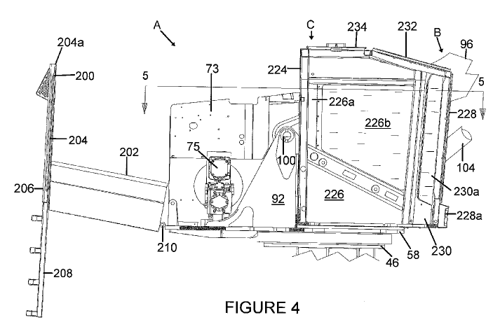

FIG. 5 shows a partial, cross sectional view of the material handling device of FIG. 1 according to section line 5-5 of FIG. 4.

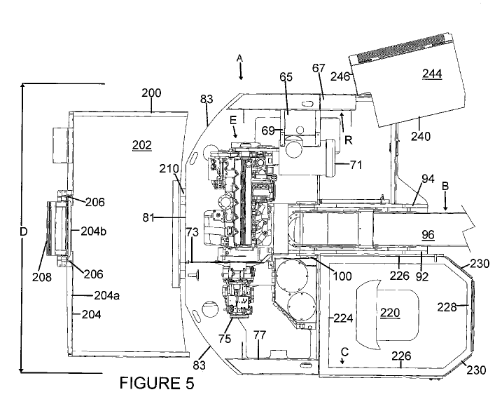

FIG. 6 shows a partial, exploded perspective view of the material handling device of FIG. 1.

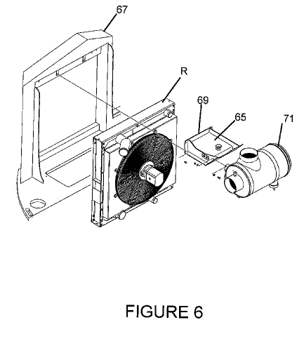

All figures are drawn for ease of explanation of the basic teachings of the present invention only; the extensions of the figures with respect to number, position, relationship, and dimensions of the parts to form the preferred embodiment will be explained or will be within the skill of the art after the following description has been read and understood. Further, the exact dimensions and dimensional proportions to conform to specific force, weight, strength, and similar requirements will likewise be within the skill of the art after the following description has been read and understood.

Where used in the various figures of the drawings, the same numerals designate the same or similar parts. Furthermore, when the terms “top”, “bottom”, “first”, “second”, “width”, “length”, “end”, “side”, “trailing”, “horizontal”, “vertical”, “axial”, and similar terms are used herein, it should be understood that these terms have reference only to the structure shown in the drawings as it would appear to a person viewing the drawings and are utilized only to facilitate describing the illustrative embodiment.

### DESCRIPTION

A mobile tree handling device according to the preferred teachings of the present invention is shown in the drawings and generally designated A. Generally, device A includes a longitudinally extending frame 12 which in the preferred form is articulated. Specifically, frame 12 includes a first articulated section 14 interconnected to a second articulated section 16 by an articulation joint 18. In the preferred form, joint 18 allows rotation about a horizontal longitudinal axis and about a vertical axis. To provide mobility of frame 12 along a work surface in a longitudinal direction, wheels 20 are provided upon each of sections 14 and 16 which in the preferred form are hydraulically driven, with the horizontal longitudinal axis being parallel to the longitudinal direction and the work surface. In this regard, tracks could be substituted for wheels 20 or wheels 20 could include a chain system wrapped around individual or multiple wheels 20. Frame 12 has a maximum lateral extent parallel to the work surface and perpendicular to the longitudinal direction, and in the form shown, the maximum lateral extent being at wheels 20. A fuel tank 22 is provided upon section 16. A rotatable platform 58 is rotatably mounted to section 14 by a turntable 46 about a turntable axis. It should be appreciated that platform 58 can also be pivotally mounted to section 14 to allow platform 58 to be level when device A is located on sloped contours. It should be appreciated that frame 12 including turntable 46 is formed of conventional construction and will be within the skill of the art. Although frame 12 of the articulated steering type is believed to produce synergistic results, frame 12 and the method for providing mobility to device A can have other forms according to the teachings of the present invention including but not limited to those shown in U.S. Pat. Nos. 4,326,571; 4,565,486 and 4,583,908, which are hereby incorporated by reference.

Secured to the platform 58 are a pair of upstanding boom support plates 92 and 94 which extend in a parallel, spaced relation to each other and generally perpendicular to platform 58 and turntable 46. In the preferred form, plates 92 and 94 are generally triangular in shape having a first edge secured to platform 58, a second edge extending vertically from the first side and platform 58, and a third, upper linear edge extending between the first and second sides. The second edges of plates 92 and 94 are located adjacent to and on opposite sides of the rotatable axis of turntable 46. The outer ends at the interconnection of the first and third edges of boom support plates 92 and 94 extend beyond the perimeter of turntable 46, but boom support plates 92 and 94 do not extend substantially beyond the width of wheels 20 at any position of turntable 46 rotated relative to frame 12. The inner ends at the interconnection of the second and third edges of boom support plates 92 and 94 are adjacent to the turntable axis of turntable 46.

A main boom member 96 is pivoted at its lower end adjacent the inner ends of and between plates 92 and 94 by the pin 100 defining a boom axis parallel to platform 58 and adjacent to the turntable axis. Boom member 96 is mounted for pivotal movement in a vertical boom plane extending perpendicular to platform 58 and parallel to plates 92 and 94 and over boom support plates 92 and 94 and turntable 46.

Further provided is the hydraulic ram 104 pivotally connected at its lower end between the outer ends of the interconnection of the first and third edges of boom support plates 92 and 94 by pin 106 defining a ram axis. The ram axis is parallel to platform 58 and spaced from and parallel to the boom axis, with the boom axis being at a greater spacing from platform 58 than the ram axis. The upper end of the piston 108 of the ram 104 is pivotally connected adjacent to the upper end of the boom member 96 by the pin 108a. Extension and retraction of hydraulic ram 104 pivots main boom member 96 in the boom plane.

Pivotally connected at its lower end to the upper end of main boom member 96 is the upper boom member 110 by the pin 112a. Upper boom member 110 is pivoted by the hydraulic ram 113 pivotally connected at its lower end to the main boom member 96 by the pin 114. Pivot pin 114 is located on the upper side of main boom member 96 opposite to pin 108a and located intermediate pin 108a and pin 100. The piston 116 of ram 113 is pivotally connected at its outer end to the inner ends of links 99 by a pin 117. Links 99 have outer ends pivotally connected to the upper boom member 110 by the pin 118 located on the opposite side of pin 112a than the outer ends of upper boom member 110. Links 101 have lower ends pivotally mounted to main boom member 96 intermediate and spaced parallel to pin 112a and pin 108a and having upper ends pivotally mounted by pin 117 to links 99 and piston 116 of ram 113.

Pivotally connected by the pin 124 to the outer end of upper boom member 110 is the tree processing member S. Tree processing member S can be of a variety of forms according to the desired use of device A. As an example, tree processing member S could be in the form of a grapple as shown or in the form of a harvester and/or cutting head available in the field of tree handling.

It should be appreciated that pins 100 and 106 are in a spaced and parallel relation to platform 58 and generally perpendicular to the rotatable axis of turntable 46. Pin 100 is elevated above platform 58 and pin 106. Although the geometry of boom B as shown and described is believed to provide more lifting power, it should be appreciated that boom B can have other constructions and/or geometries than shown and described according to the teachings of the present invention.

Mounted upon platform 58 behind plates 92 and 94 is a power supply means in a preferred form of an internal combustion engine E which supplies power to wheels 20, frame 12, boom B and tree processing member S. In the preferred form, engine E is at least a 300 horsepower diesel engine purchased from existing suppliers. Engine E has a longitudinal extent or engine length parallel to platform 58 and to the crank shaft axis and between the first and second block ends. Engine E has an engine width parallel to platform 58 and perpendicular to the engine length, with the engine length being greater than the engine width. In the preferred form, engine E is mounted to platform 58 with the crank axis parallel to and spaced behind pivot pin 100, with the turntable axis located intermediate engine E and the ram axis. Further, plates 92 and 94 and boom B are located spaced from and intermediate the first and second block ends of engine E such that the boom plane extends intermediate the first and second block ends of engine E. Further, the longitudinal extent between the first and second block ends of engine E is less than the maximum width of platform 58, with the first and second block ends of engine E spaced inwardly from the extent of platform 58 parallel to pivot pin 100.

Radiator R in fluid communication with and providing cooling for engine E is mounted parallel to plates 92 and 94 and generally along a tangent to the rotatable axis of turntable 46. Radiator R is laterally offset from engine E and in particular, is not longitudinally aligned with engine E. In particular, radiator R in the most preferred form has a forward extent generally coincident to the forward extent of pivot pin 100 and a rearward extent generally coincident to the forward extent of engine E. Due to the misalignment, fan F for the radiator R is not driven directly from the crank shaft of engine E but in the preferred form is hydraulically or electrically driven. Radiator R has a maximum radial, radiator extent from the turntable axis of turntable 46.

Engine E in the preferred form includes an expansion tank 65 for receiving overflow from radiator R as is conventional. However, tank 65 is mounted to radiator frame 67 to which radiator R is mounted by a bracket 69 which could be integrally or separately formed from tank 65. Tank 65 has a first end adjacent to radiator R and a second end spaced from radiator R. Bracket 69 is generally located intermediate the extent of radiator R and extends toward plates 92 and 94 and generally parallel but spaced from the crank shaft axis of engine E. Air cleaner 71 is mounted to the second end of bracket 69 and tank 65 opposite to frame 67 and spaced from radiator R. In the most preferred form, air cleaner 71 is generally cylindrical in shape having an axis parallel to but spaced from radiator R and platform 58 and perpendicular to the crank shaft axis of engine E. Thus, it can be appreciated that bracket 69 performs multiple functions, namely, mounting tank 65 as well as air cleaner 71. In this regard, mounting air cleaner 71 in this manner is advantageous as it can be positioned relatively close to platform 58 and is at a location in front of engine E.

Platform 58 further includes a bulkhead plate 73 extending parallel to mounting plates 92 and 94 generally from the forward extent of pivot pin 100 to the rearward extent of platform 58. The second block end of engine E abuts and is preferably secured to plate 73. First and second hydraulic pumps 75 are mounted to plate 73 opposite to engine E and are driven by the crank shaft of engine E. In the preferred form, the first hydraulic pump 75 generally operates wheels 20, joint 18 and turntable 46 while the second hydraulic pump 75 operates boom B and tree processing member S. A heat exchanger 77 associated with pumps 75 is mounted parallel to but spaced from plates 92 and 94 and radiator R and generally along a tangent to the rotatable axis of turntable 46. Heat exchanger 77 is laterally offset from engine E and in particular is not longitudinally aligned with engine E. In particular, heat exchanger 77 in the most preferred form has a forward extent generally coincident to the forward extent of pivot pin 100 and a rearward extent generally coincident to the forward extent of engine E.

In the preferred form, radiator R and heat exchanger 77 are spaced at a spacing D generally equal to and define the maximum lateral extent of platform 58 which in the preferred form is equal to and preferably less than the maximum lateral extent of wheels 20 and in the most preferred form is generally equal to 88% of the maximum lateral extent of wheels 20. The turntable axis is located intermediate radiator R and heat exchanger 77.

Platform 58 further includes a generally flat rear profile 81 of a lateral extent substantially shorter than spacing D and in the most preferred form which is generally equal to 35% of spacing D. Engine E is located intermediate rear profile 81 and the turntable axis. Platform 58 further includes arcuate portions 83 extending between the rearward extent of radiator R and heat exchanger 77 and rear profile 81. Arcuate portions 83 have radii slightly greater than one half of spacing D and in the preferred form about 125% of half of spacing D or in other words the radiator extent from the turntable axis and generally equal to half of the maximum lateral extent of wheels 20. The lateral extent of profile 81 is generally equal to but slightly larger than engine E including pumps 75.

Device A further includes a pivotal gullwing cover 200 of generally L-shaped cross sections. In particular, cover 200 includes a support panel 202 having top and bottom edges of a shape corresponding to profile 81 and arcuate portions 83 and with side edges of a shape corresponding to and for abutting with radiator R and heat exchanger 77.

Cover 200 further includes a cover panel 204 secured to the top edge of support panel 202 and having a periphery corresponding to the top edges of support panel 202, radiator R, and heat exchanger 77. The front edge 204a of panel 204 is generally linear except for a cutout 204b of a lateral extent corresponding to and for receipt of boom B, with cutout 204b extending to the top edge of panel 202 and including suitable bracing to maintain panel 204 as a single component. Located on opposite sides of cutout 204b are slides 206 for slideably receiving a ladder 208. Ladder 208 includes side rails slideably received in slides 206, rungs extending between the side rails, and a closure panel for closing cutout 204b aside from adjacent to front edge 204a for receipt of boom B in cutout 204b between slides 206 and the side rails of ladder 208.

Cover 200 is pivotally mounted to platform 58 by a hinge 210 located between profile 81 and the bottom edge of support panel 202. In the most preferred form, cover 200 is pivoted relative to platform 58 by a suitable mechanism such as a hydraulic ram or the like, and preferably powered even without engine E running. It should be appreciated that cover 200 is pivotal between an operating position and a service position. In the operating position, panel 202 extends vertically generally perpendicular to platform 58, and with panel 204 extending generally horizontally over platform 58. Ladder 208 can be positioned over cutout 204b when cover 200 is in the operating position. In the operating position, cover 200 encloses engine E, platform 58, pumps 75, air cleaner 71 and other operating components from the elements. In the service position, support panel 202 extends generally horizontally, parallel to and contiguous with platform 58, with the top edge of panel 202 located below an upper extent of engine E and with panel 204 extending vertically generally perpendicular upward from panel 202. Thus, the operator or maintenance personnel can stand on support panel 202 during servicing, and with the total area including engine E, pumps 75, and components associated therewith fully exposed. In the service position, ladder 208 can be slid downwardly relative to panels 202 and 204. Thus, an operator can climb ladder 208 and enter cover 200 through cutout 204b to allow standing upon panel 202 for servicing engine E, pumps 75, air cleaner 71 and other operating components. Suitable provisions such as removable pin locks can be provided to maintain ladder 208 in position relative to panel 204 during movement of cover 200.

A cab C for the operator is further provided upon platform 58 parallel to and outside of the boom plane forwardly of the pivot pin 100 and cover 200 in the operating position, with the turntable axis located intermediate cab C and engine E. In the preferred form shown, cab C is located to the right of boom B or in other words boom B would be on the operator's left when seated in seat 220 and facing forward. In the preferred form shown, cab C is designed to enhance operator visibility and comfort and to minimize detrimental engagement of tree limbs during operation while providing a uniquely aesthetic appearance. In particular, cab C includes a back partition 224 extending generally perpendicularly from platform 58 and generally from the forward extents of heat exchanger 77 and bulkhead plate 73 and to plate 92. In the most preferred form, partition 224 can include a window 224a located above panel 204 when cover 200 is in its operating position, with window 224a including suitable grills for safety reasons.

Cab C further includes inner and outer side partitions 226 extending parallel to and spaced from each other, extending generally perpendicular to back partition 224, extending along a tangent to the turntable axis, and extending parallel to radiator R and heat exchanger 77. The turntable axis is located intermediate the outer side partition 226 and radiator R. Each of side partitions 226 include rear and front windows 226a and 226b. The top edges of windows 226a and 226b are generally horizontal and parallel to platform 58. The lower edges of windows 226a and 226b extend at a nonparallel, acute angle in the order of 45° relative to platform 58 and in the preferred form parallel to and spaced from the upper linear edges of plates 92 and 94. In the most preferred form, window 226a has a width which is substantially less and in the preferred form about 50% of the width of window 226b. In the most preferred form, outer side partition 226 includes a door 226c including window 226b and which is hinged to allow access into cab C by the operator. In the preferred form, heat exchanger 77 extends parallel to and contiguous with outer side partition 226, and bulkhead plate 73 extends parallel to and contiguous with inner side partition 226.

Cab C further includes a front partition 228 located generally parallel to and spaced from back partition 224 and perpendicular to side partitions 226. Front partition 228 in the preferred form has a lateral width less than back partition 224. Located at the bottom of front partition 228 are headlights 228a. Partition 228 has a window 228b of a rectangular shape and including suitable grills for safety reasons. In the most preferred form, the top edge of window 228b is generally horizontal and parallel to platform 58 and at a greater elevation than the top edges of windows 226a and 226b.

Cab C further includes inner and outer corner partitions 230 extending between the front edges of partitions 226 and the side edges of front partition 228. In the most preferred form, partitions 230 extend at an angle of 45° from each of partitions 226 and 228. In the preferred form, partition 230 includes a window 230a having a polygonal shape. Specifically, the front and back edges are generally parallel to each other and the front edges of windows 226b and the side edge of window 228b and generally perpendicular to platform 58. The bottom edges of windows 230a extend at a nonparallel, acute angle in the order of 28° relative to platform 58 and in the preferred form equal to the acute angle of the bottom edges of windows 226a and 226b and generally aligned therewith. In the most preferred form, the top edge of windows 230a include a first linear portion extending at a small acute angle in the order of 8° to platform 58 at an elevation generally equal to the top edge of window 228b. A second linear portion extends from the first linear portion to the back edge at an inside obtuse angle, with the first and second linear portions extending at an angle in the order of 113° to each other and with the second linear portion extending from the back edge in the order of 148°.

Cab C includes a roof window 232 having a front edge generally corresponding to the top edges of partition 228 and the first linear portions of partitions 230, parallel side edges of a lateral spacing less than that between portions 226, and a rear edge extending perpendicularly between the side edges. Roof window 232 extends at a nonparallel, acute angle relative to platform 58 in the order of 15°. In the most preferred form, roof window 232 includes grills for safety reasons.

A roof partition 234 extends between back partition 224 and roof window 232 and in the most preferred form is generally rectangular in shape. Roof partition 234 extends at an obtuse angle to roof window 232, generally perpendicular to back partition 224, and is generally parallel to platform 58 but could be slightly sloped to shed water.

Cab C further includes side roof partitions 236 of a polygonal shape corresponding to the top edges of partitions 226, the second linear portions of partition 230, the side edges of roof window 232 and roof partition 234, and the side edges of back partition 224. It should be appreciated that side roof partitions 236 slope inwardly from partitions 226, with the outer side roof partition 236 sloping towards the turntable axis.

It should be appreciated that platform 58 and plates 92 and 94 have a longitudinal extent generally equal to but slightly less than partitions 226. In the most preferred form, the third edges of plates 92 and 94 are generally at the same elevation above platform 58 as the bottom edges of windows 226a and 226b.

Platform 58 on the opposite side of boom B from cab C has a longitudinal extent generally equal to the rear edge of windows 226b. In the preferred form, device A includes a generally L-shaped cover 240. In particular, cover 240 includes a support panel 242 having linear top, bottom and side edges. Cover 240 further includes a cover panel 244 secured to the top edge of support panel 242 and is a generally rectangular shape. Cover 240 also includes an outer side panel 246 extending from support panel 242 and cover panel 244. Outer side panels 246 have a front edge for abutting with radiator R. The inner edge of cover panel 244 abuts with front edge 204a. Cover 240 is pivotally mounted to platform 58 such as about a vertical axis relative to radiator R. By opening cover 240, access is provided to air cleaner 71, radiator R, valves for the hydraulic equipment, toolboxes, and the like.

It should be appreciated that the maximum radial extent from turntable axis of turntable 46 of platform 58, cab C, engine E, the ram axis defined by pin 106, radiator R, gullwing cover 200 in its operating position, heat exchanger 77, and cover 240 in its closed position is within the maximum lateral extent of frame 12 for all rotatable positions of platform 58 360° around the turntable axis of turntable 46. Although the ability to rotate platform 58 within the maximum lateral extent of frame 12 of material handling device A of the present invention can be accomplished by conventional material handling devices, device A of the preferred form of the present invention is advantageous thereover. Specifically, most such conventional material handling devices had their engines mounted upon the frame rather than the rotatable platform. However, frame mounted engines result in increased machine height and complicates hydraulic systems. Such conventional material handling devices having engines mounted upon the rotatable platform had engines located to the side of the cab opposite to the boom. Further, with engines mounted to the side of the cab, the boom pivot axis was mounted to the rear of the turntable axis to avoid the need for a counterweight as taught in U.S. Pat. No. 4,326,571. However, material handling device A of the preferred form does not follow conventional wisdom and mounts engine E behind cab C resulting in several advantages. Specifically, in order to do so, the boom axis is moved to be adjacent the turntable axis, with the boom plane located intermediate the engine length of engine E and with the turntable axis located intermediate engine E and the ram axis. Engine E and pumps 75 act as a counterweight for boom B, and no further counterweights are required. However, to allow 360° rotation of platform 58 while having engine E of a sufficient size to provide power for device A, radiator R and heat exchanger 77 are separated, installed on opposite sides of platform 58 , and offset from the crank shaft axis of engine E. Fan F and fans for heat exchanger 77 are driven hydraulically and thus allow better control, reversing capability for ease of keeping system clean, and for increased cooling capacity.

Having engine E mounted behind cab C provides the opportunity for better operator visibility in material handling device A according to the preferred teachings of the present invention. Specifically, the engine located to the side of the cab does not allow visibility to that side, which is quite a handicap to the operator. According to the preferred teachings of the present invention, windows 226a and 226b are provided in the inner side partitions 226, with the bottom edges of windows 226a and 226b being parallel to and at the same elevation as the third edge of mounting plates 92 and 94 allowing operator visibility. Further, cab C has a longitudinal extent in front of platform 58 and cover 240 on the opposite side of boom B to allow visibility for the operator in cab C to both sides of cab C and of device A according to the preferred teachings of the present invention.

In addition to increased visibility to the side of device A, device A according to the preferred teachings of the present application has increased visibility to the rear of device A. Specifically, cab C includes window 224a in back partition 224 and windows 226a in inner side partition 226 to allow visibility to the rear of device A. Thus, covers 200 and 240 and the mechanical structures therein can not exceed a height which would restrict visibility through rear window 224a of cab C. In particular, the placement of air cleaner 71 of a size able to handle engine E of larger size than conventional in a low position by use of bracket 69 for burp tank 65 and off engine E meets the low profile requirements for rear visibility. Further, air cleaner 71 in the preferred form is in a good position to get outside air and route filtered air to the turbo of engine E. Additionally, the muffler for engine E can be mounted to the back side of engine E between the first and second block ends and exhausted through a hole in gullwing cover 200 in the operating position. The muffler can also be wrapped with a fire proof material to prevent fires, to reduce heat, and to deaden sound. Likewise, the air conditioner compressor can be mounted off the front of the first block end of engine E opposite pumps 75 to keep it low enough so cover 200 does not make contact. Specifically, in the most preferred form, the mechanical structure is arranged with a lower profile to minimize the height of cover panels 204 and 244.

Cab C according to the preferred form of the present invention results in increased operator comfort, safety and visibility while providing aesthetic characteristics which are distinct and appealing. Specifically, the front of cab C in the preferred form shown includes front partition 228 and corner partitions 230 rather than a planar front. Specifically, outer corner partition 230 allows the maximum extent of cab C to remain within the lateral extent of frame 12 for all rotatable positions about turntable axis of turntable 46 while allowing the distance between seat 220 and front partition 228 to be maximized. Thus, front partition 228 and cab C can be positioned in front of support plates 92 and 94 and the lower end of ram 104 pivotally mounted therebetween. This greatly increases the visibility of the operator to that side of device A. The slant of side roof partitions 234 and specifically the outer partitions 226 reduces the likelihood of contact with a tree when device A goes over an obstacle and moves from side to side. Furthermore, in the most preferred form, gauges, a radio sound system, and an IPS box are located with hinged access for servicing inside of side roof partitions 234. Also, the air conditioner/heater is floor mounted with provisions for seat 220 to be installed on top thereof according to the preferred teachings of the present invention to leave more room for operator comfort and installation of controls. As an example, the main electrical center can be mounted to the operator's left side when sitting in seat 220 with complete access to the fuses and relays. In the preferred form and to allow extra room in cab C while remaining within the lateral extent of frame 12 for all rotational positions, support plates 92 and 94 are positioned slightly in the range of 2 inches (5 cm) to the left of the turntable axis of turntable 46. The angled lower edges of window 226a and 226b enhance the ability to provide a two-tone paint scheme which is unique in the tree harvesting industry. Thus, the shape and location of cab C according to the preferred teachings of the present invention results in a larger, more comfortable cab C having increased visibility and reduced noise leads while simultaneously resulting in a trade dress which is unique and pleasing.

Bulkhead plate 73 according to the preferred teachings of the present invention also produces synergistic results. In particular, bulkhead plate 73 isolates engine E from pumps 75 and the hydraulic systems associated therewith. This reduces the risk of fire and reduces engine noise transmission to back partition 224. Furthermore, plate 73 provides a surface to mount pumps 75 and required manifolds and filters associated therewith. Additionally, plate 73 abuts with and supports panels 202 and 204 of gullwing cover 200 in the operating position.

Now that the basic teachings of the present invention have been explained, many extensions and variations will be obvious to one having ordinary skill in the art. For example, several independent and inventive aspects have been incorporated into device A of the most preferred form of the invention and which is believed to produce synergistic results. In particular, all necessary operating components for material handling device A are installed on platform 58 having a radial extent from the turntable axis to allow rotation 360° within the lateral and longitudinal extent of frame 12 and between adjacent rows of trees without contact therewith while improving operator comfort and visibility as well as improving ease of maintenance. However, a person skilled in the art my apply one or more of these inventive aspects in a material handling device of the same or different type according of the teachings of the present invention.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

What is claimed is:

1. Material handling device comprising, in combination: a frame, with the frame being movable along a work surface in a longitudinal direction, with the frame having a maximum longitudinal extent parallel to the longitudinal direction and the work surface, with the frame having a maximum lateral extent parallel to the work surface and perpendicular to the longitudinal direction; a platform, with the platform rotatably mounted to the frame about a turntable axis; a main boom member having a lower end pivotally mounted to the platform about a boom axis parallel to the platform and adjacent to the turntable axis, with the boom pivotal in a boom plane extending perpendicular to the platform; a hydraulic ram pivotally connected to the platform about a ram axis parallel to the platform and spaced from and parallel to the boom axis, with extension and retraction of the hydraulic ram pivoting the main boom member in the boom plane; an engine having a crank axis, a first block end and a second block end, with the engine having an engine length between the first and second block ends parallel to the crank axis and to the platform, with the engine having an engine width perpendicular to the engine length and parallel to the platform, with the engine length being greater than the engine width, with the turntable axis located intermediate the engine and the ram axis, with the boom plane located intermediate the first and second block ends of the engine; and a cab located parallel to and outside the boom plane, with the turntable axis located intermediate the cab and the engine, with the platform, the cab, the engine, and the ram axis having a radial extent from the turntable axis within the maximum lateral extent of the frame for all rotatable positions of the platform 360° around the turntable axis.

2. The material handling device of claim 1 wherein the engine includes a radiator mounted to the platform, with the radiator being offset from the crank axis of the engine.

3. The material handling device of claim 2 with the radiator extending along a tangent to the turntable axis, with the radiator having a radiator extent from the turntable axis, with the platform including a rear perimeter, with the rear perimeter including an arcuate portion extending from the radiator, with the arcuate portion having a radius slightly less than the radiator extent.

4. The material handling device of claim 3 with the cab having an outer side partition extending along a tangent to the turntable axis and parallel to the radiator, with the turntable axis located intermediate the outer side partition and the radiator.

5. The material handling device of claim 4 with the cab including a front partition extending perpendicular to the outer side partition, with the cab including a corner partition extending at an acute angle between the front partition and the outer side partition.

6. The material handling device of claim 5 with the cab having an inner side partition extending parallel to and spaced from the outer side partition, with the material handling device further comprising at least a first support plate extending perpendicular to the platform and parallel to the boom plane, with the first support plate including an upper linear edge extending at an acute angle to the platform and having an outer end and an inner end, with the ram axis located adjacent the outer end and the boom axis located adjacent the inner end, with the boom axis at a greater spacing from the platform than the ram axis, with the inner and outer side partitions including windows having bottom linear edges parallel to and spaced from the upper linear edge.

7. The material handling device of claim 4 further comprising, in combination: a hydraulic heat exchanger extending parallel to and contiguous with the outer side partition, with the hydraulic heat exchanger parallel to and spaced from the radiator, with the turntable axis located intermediate the radiator and the hydraulic heat exchanger.

8. The material handling device of claim 2 further comprising, in combination: a purge tank in fluid communication with the radiator, with the purge tank having a first end adjacent to the radiator and a second end spaced from the radiator; and an air cleaner for the engine, with the air cleaner secured to the second end of the purge tank spaced from the radiator.

9. The material handling device of claim 8 with the air cleaner having a generally cylindrical shape having a cleaner axis, with the cleaner axis being parallel to the platform and the radiator.

10. The material handling device of claim 1 wherein the platform includes a rear profile, with the engine located intermediate the rear profile and the turntable axis; with the material handling device further comprising, in combination: a gullwing cover having generally L-shaped cross sections, with the gullwing cover including a support panel having top and bottom edges, with the bottom edge pivotally mounted to the rear profile, with the cover including a cover panel extending from the top edge of the support panel, with the cover including an operating position and a service position, with the cover panel extending over the engine and the platform in the operating position, with the top edge of the support panel located below an upper extent of the engine in the service position.

11. The material handling device of claim 10 further including a ladder, with the support plate extending horizontally from the platform and the cover plate extending vertically from the support plate in the service position, with the cover plate having a cutout extending to the top edge of the support plate, with the ladder slideably mounted to the cover plate over the cut-out in the operating position and extending vertically in the service position.

12. The material handling device of claim 11 with the main boom member locatable in the cutout in the operating position of the cover.

13. Material handling device comprising, in combination: a frame, with the frame being movable along a work surface in a longitudinal direction; a platform, with the platform rotatably mounted to the frame about a turntable axis; a main boom member having a lower end pivotally mounted to the platform about a boom axis parallel to the platform, with the boom pivotal in a boom plane extending perpendicular to the platform; a hydraulic ram pivotally connected to the platform about a ram axis parallel to the platform and spaced from and parallel to the boom axis, with extension and retraction of the hydraulic ram pivoting the main boom member in the boom plane; an engine having a crank axis, a first block end and a second block end, with the engine having an engine length between the first and second block ends parallel to the crank axis and to the platform, with the engine having an engine width perpendicular to the engine length and parallel to the platform, with the engine length being greater than the engine width; and a cab located parallel to and outside the boom plane, with the engine including a radiator and a hydraulic heat exchanger mounted to the platform, with the turntable axis and the engine located intermediate the radiator and the hydraulic heat exchanger.

14. The material handling device of claim 13 with the radiator extending along a tangent to the turntable axis.

15. The material handling device of claim 14, with the crank axis extending generally perpendicular to the radiator and the hydraulic heat exchanger, with the radiator being offset from the crank axis of the engine, with the turntable axis located intermediate the engine and the ram axis, with the boom plane located intermediate the first and second block ends of the engine.

16. The material handling device of claim 15 with the cab having an outer side partition extending along a tangent to the turntable axis and parallel to the radiator, with the turntable axis located intermediate the outer side partition and the radiator, with the hydraulic heat exchanger extending parallel to and contiguous with the outer side partition.

17. In a material handling device including a platform having a rear profile, with an engine located adjacent the rear profile, a gullwing cover comprising, in combination: a support panel having top and bottom edges, with the bottom edge pivotally mounted to the rear profile, and a cover panel extending from the top edge of the support panel, with the support and cover panels having generally L-shaped cross sections and including an operating position and a service position, with the cover panel extending over the engine and the platform in the operating position, with the top edge of the support panel located below an upper extent of the engine in the service position.

18. The gullwing cover of claim 17 further comprising, in combination: a ladder, with the support plate extending horizontally from the platform and the cover plate extending vertically from the support plate in the service position, with the cover plate having a cutout extending to the top edge of the support plate, with the ladder slideably mounted to the cover plate over the cut-out in the operating position and extending vertically in the service position.

19. Engine system comprising, in combination: an engine; a radiator in fluid communication with and providing cooling for the engine; a purge tank in fluid communication with the radiator, with the purge tank having a first end adjacent to the radiator and a second end spaced from the radiator; and an air cleaner for the engine, with the air cleaner secured to the second end of the purge tank spaced from the radiator.

20. The engine system of claim 19 with the air cleaner having a generally cylindrical shape having a cleaner axis, with the cleaner axis being parallel to the radiator.

21. The engine system of claim 20 with the engine having a crank axis, with the radiator being offset from the crank axis of the engine.

22. Material handling device comprising, in combination: a frame, with the frame being movable along a work surface in a longitudinal direction; a platform, with the platform rotatably mounted to the frame about a turntable axis; a main boom member having a lower end pivotally mounted to the platform about a boom axis parallel to the platform, with the boom pivotal in a boom plane extending perpendicular to the platform; a hydraulic ram pivotally connected to the platform about a ram axis parallel to the platform and spaced from and parallel to the boom axis, with extension and retraction of the hydraulic ram pivoting the main boom member in the boom plane; an engine mounted on the platform; and a cab located parallel to and outside the boom plane, with the cab having an outer side partition extending along a tangent to the turntable axis, with the cab including a front partition extending perpendicular to the outer side partition, with the cab including a corner partition extending at an acute angle between the front partition and the outer side partition.

23. The material handling device of claim 22 with the cab having an inner side partition extending parallel to and spaced from the outer side partition, with the material handling device further comprising at least a first support plate extending perpendicular to the platform and parallel to the boom plane, with the first support plate including an upper linear edge extending at an acute angle to the platform and having an outer end and an inner end, with the ram axis located adjacent the outer end and the boom axis located adjacent the inner end, with the boom axis at a greater spacing from the platform than the ram axis, with the inner and outer side partitions including windows having bottom linear edges parallel to and spaced from the upper linear edge.

24. The material handling device of claim 23 with the cab further including an outer side roof partition connected to the outer side partition and to the corner partition, with the outer side roof partition extending at an acute angle to the outer side partition towards the turntable axis.

25. The material handling device of claim 24 with the cab further including a roof window connected to the front partition, the corner partition and the outer side roof partition, with the roof window extending at a nonparallel, acute angle relative to the platform, with the cab further including a roof partition connected to the roof window and the outer side roof partition, with the roof partition extending at an obtuse angle to the roof window, with the outer side roof partition being of a polygonal shape.
